(19) United States
(12) Patent Application Publication
(10) Pub. No.: US 2022/0112568 A1
(43) Pub. Date: Apr. 14, 2022

(54) METHOD FOR PRODUCING A STEEL BLANK AND TEMPERATURE-ADJUSTING STATION

(71) Applicant: BENTELER AUTOMOBILTECHNIK GMBH, Paderborn (DE)

(72) Inventors: Cordt ERFLING, Paderborn (DE); Markus KETTLER, Schlangen (DE); Frank RABE, Hiddenhausen (DE); Dimitri SCHNEIDER, Schloss Holte-Stukenbrock (DE)

(21) Appl. No.: 17/450,727

(22) Filed: Oct. 13, 2021

(30) Foreign Application Priority Data
Oct. 14, 2020 (DE) 10 2020 127 057.7

(51) Int. Cl. C21D 1/42; B21D 22/02; B21D 37/16

(52) U.S. Cl. CPC C21D 1/42; B21D 37/16; B21D 22/022

(57) ABSTRACT

A method and a device for adjusting the temperature of steel blanks, such that a plurality of temperature-adjusting stations are used in order to heat the steel blanks in stages with low temperature gradients.

### RELATED APPLICATIONS

The present application claims priority of German Application Number 10 2020 127 057.7 filed Oct. 14, 2020, the disclosure of which is hereby incorporated by reference herein in its entirety.

### FIELD

The present disclosure relates to a method for heating a steel blank.

### BACKGROUND

The present disclosure relates to a temperature-adjusting station for use in a hot-forming and press-hardening process.

Hot-forming and press-hardening technology are used for producing automobile components. In this respect, use is made of hardenable steel alloys, for example manganese-boron steel, which are heated above a temperature which is at least partially above the austenitization temperature. The austenitization temperature is also referred to as AC3 temperature and, depending on the type of steel, is above 900° C.

A blank heated in this way is subsequently transferred into a press in the hot state and then formed approximately at the AC3 temperature, and immediately thereafter is quickly cooled or quenched in such a way that a transformation of the microstructure takes place and a hardened microstructure arises.

Corresponding production methods include, for example, from EP 2 907 881 B1, EP 3 530 760 A1 and EP 3 276 012 A1.

In addition, contact heating is used here for the heating. In this respect, use is made of contact temperature-adjusting stations in order to heat the blank to a temperature greater than AC3 at least in certain regions.

Owing to the intense heating of the blank within a very short amount of time, from room temperature at the start to over 900° C., the temperature-adjusting stations, specifically the heating plates used, are subjected to load on account of the expansion forces of the blank itself (when the blank is being heated).

An object of the present disclosure is to provide a heating option in which the temperature of a respective blank is adjustable partially individually and effectively with a shortened heating time.

The object stated above is solved according to the disclosure by a method for heating a steel blank.

An article-related part of the object is solved according to the disclosure by a temperature-adjusting station for use in a hot-forming and press-hardening process.

### SUMMARY

According to the disclosure, a plurality of temperature-adjusting stations are arranged one behind the other as heating station in a hot-forming line.

All the temperature-adjusting stations are in the form of contact temperature-adjusting stations. However, first heating, for example homogeneously, to a temperature takes place for the purpose of metallurgically bonding a metallic coating is possible, like an AlSi coating as intermetallic phase; this is able to be performed, for example, by a continuous furnace or multi-level furnace.

The basic idea, however, is that at least two, three, or four temperature-adjusting stations connected one behind the other in a row perform heating in stages with a respective temperature difference of less than 300° C., less than 250° C., or less than 200° C.

In at least one embodiment, the time in which the temperature is increased per station is shortened. Heating is not necessary to be performed from ambient temperature to over 900° C. in only one station, for example. By contrast, a temperature difference of less than 300° C. has to be overcome per temperature-adjusting station.

The time required per station for this is thus shorter. A plurality of stations connected one behind the other is able to heat the blanks in a shorter cycle time in each case. Overall, the cycle time is able to be divided over a plurality of temperature-adjusting stations and reduced as a result, from a conditionally absolute point of view. Cycle times of less than 20 seconds for the purpose of temperature adjustment per temperature-adjusting station is able to be realized.

In at least one embodiment, only a relatively low temperature difference per temperature-adjusting station is set, and thus the thermal expansion per temperature-adjusting station of tool components which make contact with the blank the temperature of which is to be adjusted is kept as small as possible by virtue of the temperature differences achieved in each temperature-adjusting station.

An optimum temperature transition is realizable during contact heating, since the preset contact pressure changes negligibly over the heating period by virtue of low thermal expansions. An optimally set contact pressure per temperature-adjusting station is necessary, however, since optimum heat transfer is ensured from a temperature-adjusting plate of the temperature-adjusting station to the blank to be heated takes place during the contact heating period.

In at least one embodiment, a preheating station is provided to perform preheating to 500° C. to 600° C. and/or to metallurgically bond a precoat, e.g. AlSi precoat, to the blank upstream and then to perform preheating to approx. 500° C. firstly as intercooling. This takes place between approx. 550 to 650° C. The preheating is able to be performed to a starting temperature of 500° C. to 650° C. in a furnace.

In the case of precoated blanks, such as e.g. an AlSi coat, the blank is able to firstly be austenitized and in the process metallurgically bonded to the steel base material to form intermetallic phases, and then cooled to the stated preheating temperature of approx. 500° C. to 650° C. in the same furnace or in a downstream transfer of air or with air.

This is able to take place, for example, in a continuous furnace or else in a multi-level furnace. Following after this in that case are at least two temperature-adjusting stations, which perform heating for example from 600° C. to 775° C., and a second temperature-adjusting station, which performs heating from 750 to 775° C. to 900° C. or more. Consequently, a temperature difference of less than 300° C., less than 250° C., or less than 200° C. is overcome per temperature-adjusting station, and therefore with the respective contact heating only a low thermal expansion of the blank in the respective temperature-adjusting station arises, and therefore an optimally preset contact pressure is able to be utilized.

Within the meaning of the disclosure, a respective temperature-adjusting station is able to be formed for example by two temperature-adjusting plates, which are arranged on opposite sides. The two temperature-adjusting plates are able to be actively heated. However, in some embodiments only one temperature-adjusting plate is actively heated, whereas the other temperature-adjusting plate is arranged either as an isolated backing layer or as a passive abutment.

When there is a partial temperature adjustment, individual regions of the respective temperature-adjusting plate are able to be heated. In some embodiments, regions are able to be omitted, such that no contact takes place and/or insulating material or cooling means are arranged in regions which are not to be heated.

A further aspect of the disclosure provides that the temperature-adjusting plate itself has an allocated heating conductor. The heating conductor is incorporated in the temperature-adjusting plate itself. For this purpose, the temperature-adjusting plate is to be produced from non-magnetic material and/or a magnetic material. However, a temperature-adjusting plate of magnetic material is able to be used. The heating conductor heats the temperature-adjusting plate itself. This heating is able to be performed both by virtue of heat conduction of the heating conductor itself, but also inductively. This means that the heating conductor heats the temperature-adjusting plate itself on account of its dedicated heating and heat conduction from the heating conductor to the temperature-adjusting plate. Optionally in addition, in some embodiments, the heating conductor itself is able to heat the temperature-adjusting plate inductively, that is to say by means of induced eddy current losses. In that case, the temperature-adjusting plate itself heats the blank by virtue of heat conduction from the temperature-adjusting plate to the blank.

In turn and optionally in addition, in some embodiments, the heating conductor itself also inductively heats the blank. This means that the heating conductor is energized during the contacting operation and therefore is also able to inductively heat the blank on account of its electric field.

Therefore, the present disclosure relates to a method for using this heating technology, but at the same time also to a temperature-adjusting station, where a heating conductor is arranged in a temperature-adjusting plate and according to the disclosure the heating conductor heats the temperature-adjusting plate and additionally inductively heats the blank.

The temperature-adjusting plate is also referred to below as basic body.

In order to heat the basic body conductively and inductively, the jacket heating-conductor loop embedded therein has to be supplied with an electrical AC voltage, with an AC voltage in the mid-frequency range of 0.5 kHz to 50 kHz.

On account of the incomplete shielding of the jacket heating-conductor loop supplied with an electrical AC voltage, the alternating magnetic field strays into the regions of the steel blank that are to be heated and also brings about also brings about there, in addition to the increase in temperature as a result of heat conduction and heat radiation, an increase in temperature as a result of inductively generated electrical eddy current intensities.

The arrangement of at least 3 jacket heating-conductor loops to form an inductor allows for a traveling magnetic field of a varying intensity and frequency and/or velocity to be created, which rolls (kneading, stirring) or grinds (rubbing, shaking) the metal microstructure or the grains thereof, and thus, by virtue of internal friction, uniformly increases the temperature of the regions of the blank which heat up.

There is likewise the possibility of heating the heatable basic body and/or the blank by means of induction above the temperature level of the electrical heating conductor.

Because of the fact that fields are generally not delimited but are able to only be attenuated, a blank located in the exterior space of the basic body is passed through by a stray magnetic field. If the voltage induced by the stray magnetic field in the blank impels an electrical eddy current intensity which produces the heat in a region of the blank with a greater thermal power than this region of the blank is able to discharge to the surroundings, this region is inductively heated, even if the blank is not electrically attached or materially bonded to the basic body.

Consequently, a region to be heated of a blank should be arranged at the smallest possible distance from a jacket heating conductor which extends approximately parallel to this region and is supplied with an electrical AC voltage. Specifically, distances between the blank surface and the jacket heating conductor of 2 mm to 50 mm and/or distances between two jacket heating conductors of between 5 mm and 100 mm have proven to be effective for a sufficiently homogeneous additional inductive input of heat.

### BRIEF DESCRIPTION OF THE DRAWINGS

Further features, characteristics and aspects of the disclosure are illustrated in the following figures. Various embodiments according to the disclosure are depicted in schematic figures. These serve for simple understanding of the disclosure. In the figures

FIG. 1 shows a hot-forming line according to the disclosure for adjusting the temperature of a steel blank with a continuous furnace,

FIG. 2 shows an alternative configuration with a multi-level furnace according to the disclosure,

FIG. 3A and FIG. 3B show cross-sectional views according to the disclosure,

FIG. 4A and FIG. 4B show longitudinal views and cross-sectional views of a temperature-adjusting station according to the disclosure,

FIG. 5 shows various views of heating temperature-adjusting plates with heating conductors according to the disclosure,

FIG. 6 shows the temperature-adjusting effect according to the disclosure,

FIG. 7A-FIG. 7D show cross-sectional shapes of a heating conductor that differ from one another according to the disclosure,

FIG. 8A and FIG. 8B show a respective plan view of a temperature-adjusting plate according to the disclosure, and

FIG. 9 shows a cross section along the sectional line IX-IX from FIG. 8A of a temperature-adjusting plate according to the disclosure.

### DETAILED DISCLOSURE

The same reference signs are used in the figures for components which are identical or similar, although a repeated description is omitted for reasons of simplification.

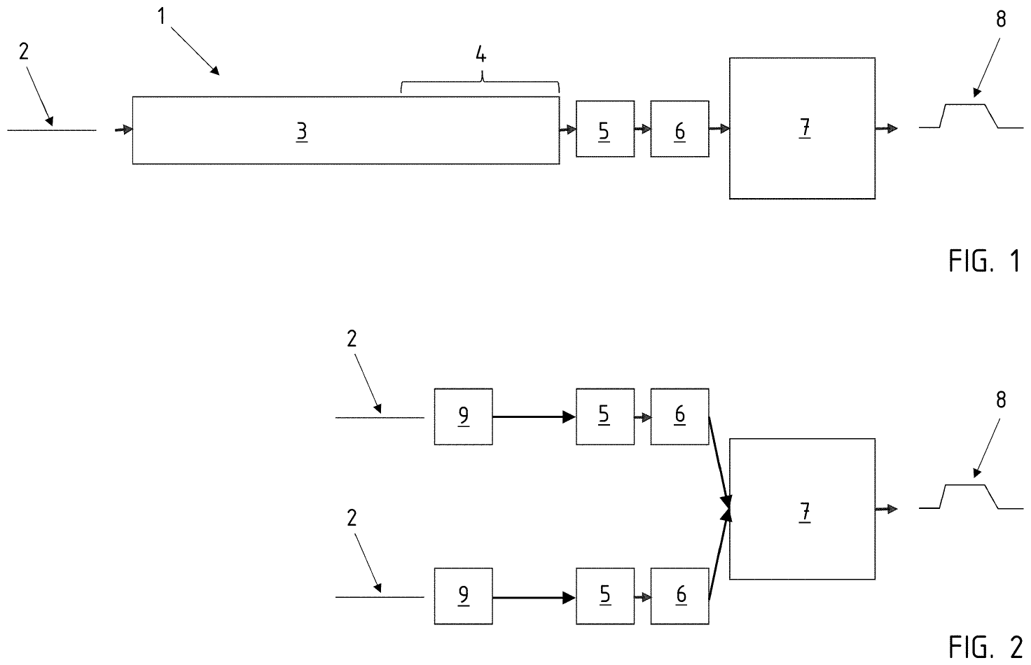

FIG. 1 shows a hot-forming line 1 according to the disclosure. Here, firstly steel blanks 2 are provided, which are transferred into a continuous furnace 3. At the end of the continuous furnace 3 there is able to be a region of homogeneous intercooling 4, followed by two temperature-adjusting stations 5, 6 and a hot-forming and press-hardening tool 7. After this, a hot-formed and press-hardened component 8 is removed from the hot-forming and press-hardening tool 7.

Firstly, a steel blank 2 is placed in the continuous furnace 3, and is then heated to a temperature of 500 to 600° C. In the continuous furnace 3, firstly a temperature adjustment to above austenitization temperature is carried out in order to induce homogenization of the steel material and/or metallurgical bonding with a precoat. In this case, homogeneous intercooling 4 is performed in one region. When being removed from the continuous furnace 3, the steel blank 2 then has a temperature of between 500 and 600° C. The steel blank 2 is then transferred into a first temperature-adjusting station 5, followed by a second temperature-adjusting station 6. In each temperature-adjusting station 5, 6, heating takes place at least partially over a temperature difference per temperature-adjusting station of less than 300° C., less than 250° C., or less than 200° C.

The steel blank 2 then has a temperature of 750 to 775° C. in or after the first temperature-adjusting station 5. After the second temperature-adjusting station 6, the steel blank 2 at least partially has a temperature of greater than AC3, therefore greater than 900° C., or greater than 920° C. After this, the blank which has been partially temperature-adjusted in this way is transferred into a hot-forming and press-hardening tool 7 and hot-formed and press-hardened therein.

In FIG. 2, the steel blank 2 is placed into a multi-level furnace 9. As an alternative, a second multi-level furnace 9 is able to be arranged as illustrated in the bottom line in relation to the plane of the drawing, and is also able to be configured as an intermediate buffer. Respective contact heating then takes place in a respective first and second temperature-adjusting station 5, 6 in the same way as described above from approx. 500 to 600° C. to a temperature partially greater than the AC3 temperature in at least two steps.

Overall, in FIG. 1, cycle times of less than 30 seconds are possible, or less than 20 seconds, per temperature-adjusting station 5, 6 and thus over the entire process to be achieved. In the case of the exemplary embodiment of FIG. 2, the hot-forming and press-hardening tool 7 is supplied from two heating lines and is able to be charged from the top or bottom heating line.

FIG. 3A and FIG. 3B show a longitudinal section and a cross section of a temperature-adjusting station 5, 6 according to the disclosure. What is illustrated is a bottom temperature-adjusting plate 10, a heating conductor 11 being arranged below the temperature-adjusting plate 10. The heating conductor 11 is also able to be integrated in the temperature-adjusting plate 10 itself. In that case, the temperature-adjusting plate 10 has protruding projections 12, which represent a prolongation of the temperature-adjusting plate 10 itself and, in the closed state, make partial contact with and thus partially adjust the temperature of a steel blank 2 arranged therebetween, by virtue of heat conduction. The cross section according to FIG. 3b shows that two steel blanks 2 are able to be arranged in a temperature-adjusting station 5, 6 at the same time. An insulating material 13 is able to be arranged between the individual projections 12. An insulating counter plate 14, for example in the form of a second temperature-adjusting plate, is illustrated on the opposite side. Arranged therein themselves in turn are passive heating plates 15, which as a result of permanent operation correspondingly have a temperature of heat conduction over the metal blank 2, but do not have to be actively heated themselves.

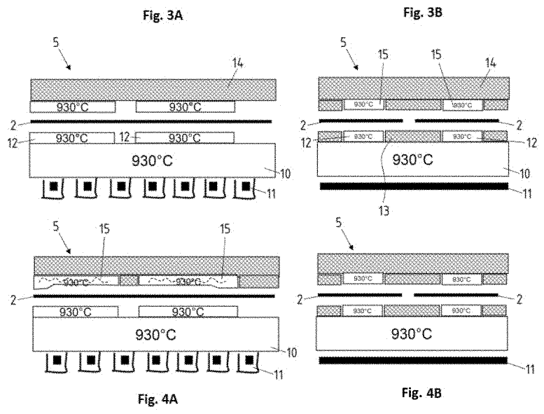

In principle, FIG. 4A and FIG. 4B show a configuration variant analogous to FIG. 3. However, by contrast to FIG. 3 in longitudinal section, there is the possibility here of adjusting the temperature of a steel blank 2 with wall thicknesses which differ from one another over its longitudinal extent. For this purpose, the top heating plates 15 are formed with a different surface profile, which is matched to the different wall thicknesses of the steel blanks.

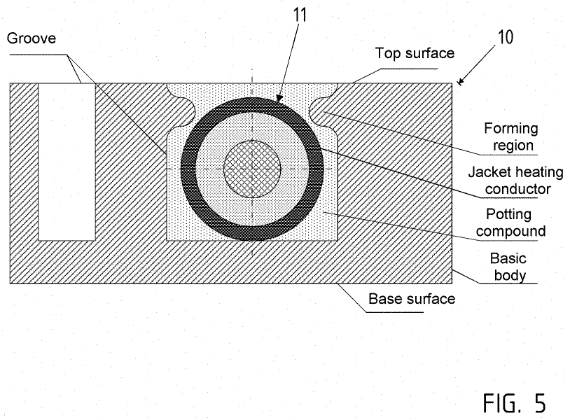

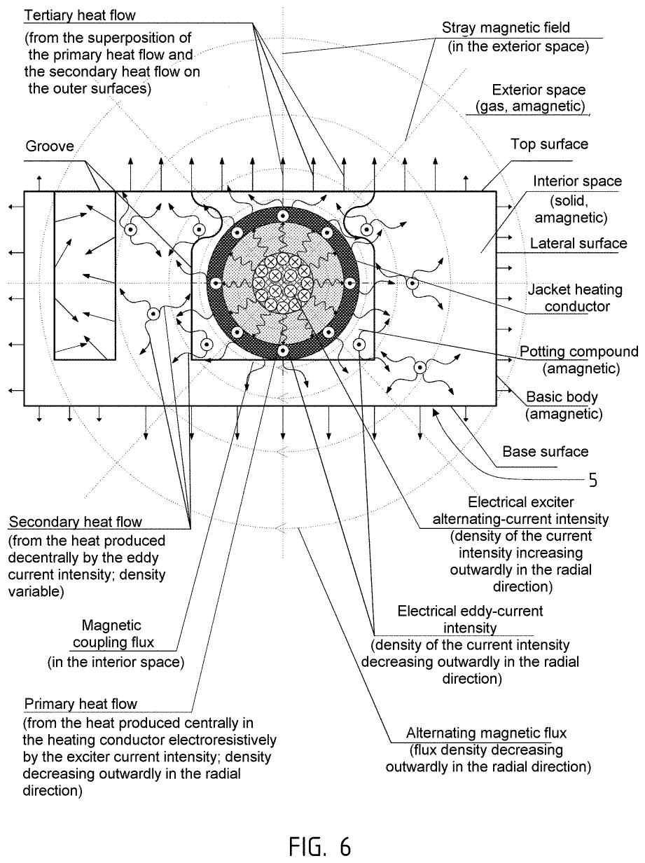

FIG. 5 shows a cross section through a temperature-adjusting plate 10 with an integrated heating conductor 11. The integrated heating conductor is arranged in the basic body of the temperature-adjusting plate 10 and then poured out with a potting compound, with the result that a heating conductor 11 is fixed in the basic body. According to the disclosure, the temperature-adjusting effect illustrated in this way in FIG. 6 is able to be practiced. Firstly, a primary heat flow is created by the heating conductor 11 itself and discharged to the temperature-adjusting plate 10. A secondary heat flow is created decentrally within the temperature-adjusting plate 10 itself on account of the heat flow intensity and in turn here then discharged to individual passing blanks 2. A tertiary heat flow results from the superposition of the primary heat flow and the secondary heat flow on the outer surfaces of the temperature-adjusting plate 10. In addition and not illustrated in more detail, however, an inductive temperature adjustment is able to be performed on a steel blank 2 to be heated by virtue of the alternating magnetic flux.

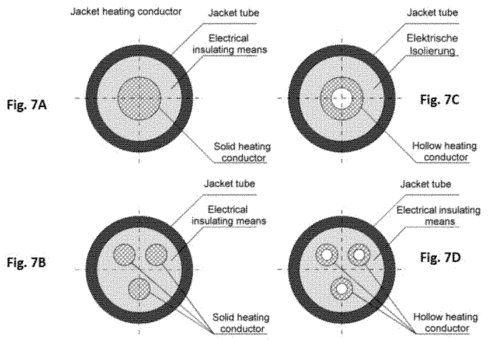

FIG. 7A, FIG. 7B, FIG. 7C, and FIG. 7D show cross-sectional shapes of a heating conductor 11 that differ from one another. The heating conductor 11 is arranged in each case in the form of a jacket heating conductor in the temperature-adjusting plate 10 itself. Said jacket heating conductor has a jacket tube, an electrical insulating means and a heating conductor 11, arranged therein, in its own right. The heating conductor 11 is able to be produced as a solid heating conductor, in the form of a plurality of heating conductors or else as a respective hollow heating conductor. In that case, the heating conductor 11 itself is subjected to an electrical current and then heated, in accordance with the principle illustrated in FIG. 6.

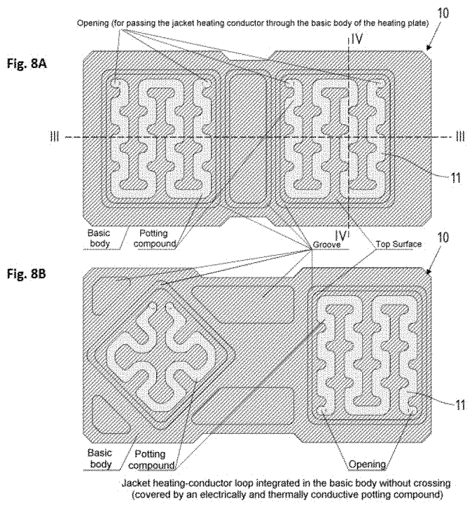

FIG. 8A and FIG. 8B show a respective plan view of a temperature-adjusting plate 10 according to the disclosure. What is illustrated is that the respective heating conductor 11 is arranged in an extending groove. This groove is able to extend for example in accordance with the principle of a meander, thus in a meandering or sinuous manner, only partially beyond the respective surface of the temperature-adjusting plate 10. The partial regions illustrated in FIG. 3A, FIG. 3B, FIG. 4A, and FIG. 4B are able to be formed with a respective temperature of 930° C. in the course of a longitudinal section. A longitudinal sectional line is illustrated by III-III in FIG. 8A. If the heating conductor 11 is arranged in the temperature-adjusting plate 10, such that the heating conductor 11 is fixed in place with a potting compound. In that case, the heating conductor 11 is able to be passed through illustrated openings in the respective rear side 17 through the basic body of the temperature-adjusting plate 10 and connected, which connection is not illustrated in more detail in electrical terms.

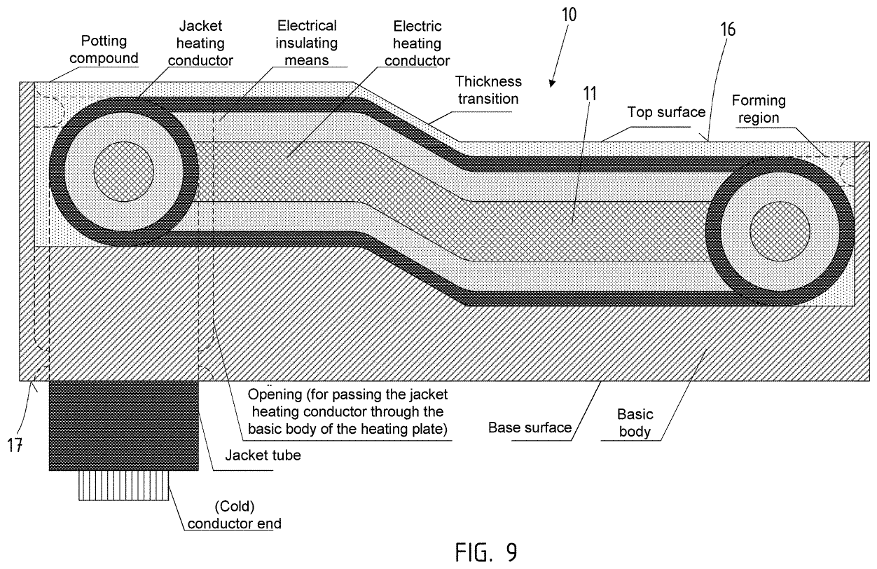

FIG. 9 shows a cross section along the sectional line IX-IX from FIG. 8A of a temperature-adjusting plate 10. Here, the heating conductor 11 is arranged in the temperature-adjusting plate 10. The surface 16 of the temperature-adjusting plate 10 itself has a thickness step change, such that tailored blanks or patched steel blanks, that is to say steel blanks which are double-layered in certain portions, with different wall thicknesses are able to be processed as steel blanks 2.

Illustrated on a rear side 17 is a corresponding conductor end, in order to electrically connect the heating conductor 11, which is present in the temperature-adjusting plate 10 and is not illustrated in more detail, to an energy source.

The foregoing description of some embodiments of the disclosure has been presented for purposes of illustration and description. The description is not intended to be exhaustive or to limit the disclosure to the precise form disclosed, and modifications and variations are possible in light of the above teachings. The specifically described embodiments explain the principles and practical applications to enable one ordinarily skilled in the art to utilize various embodiments and with various modifications as are suited to the particular use contemplated. Various changes, substitutions and alterations are able to be made hereto without departing from the spirit and scope of the disclosure.

1-10. (canceled)

11. A method of making a heated steel blank, the method comprising:
hot-forming the steel blank;
press-hardening the steel blank; and
heating the steel blank using a plurality of temperature-adjusting stations, each temperature-adjusting station of the plurality of temperature-adjusting stations being arranged one behind the other in a row, wherein heating the steel blank comprises heating the steel blank in stages at each of the plurality of temperature-adjusting stations to at least an austenitization temperature, and the heating is performed at a temperature difference of less than 300° C. at each of the plurality of temperature-adjusting stations.

12. The method according to claim 11, wherein at least three temperature-adjusting stations of the plurality of temperature-adjusting stations are arranged one behind the other.

13. The method according to claim 11, wherein the plurality of temperature-adjusting stations are operated by contact heating.

14. The method according to claim 11, further comprising transporting the steel blank between the plurality of temperature-adjusting stations using a transfer system.

15. The method according to claim 11, wherein the heating of the steel blank is performed in a first temperature-adjusting station of the plurality of temperature-adjusting stations, the heating of the steel blank is at least in certain portions of the steel blank at a heating rate of 15 to 50 K/s.

16. The method according to claim 11, wherein each of the temperature-adjusting stations has a temperature-adjusting plate, the heating of the steel blank is performed by the temperature-adjusting plate, and additional inductive heating of the steel blank is performed by a heating conductor of the temperature-adjusting plate.

17. The method according to claim 11, further comprising applying a contact pressure to the steel blank to be heated when each of the temperature-adjusting stations is in a closed state.

18. The method according to claim 11, wherein at least four temperature-adjusting stations of the plurality of temperature-adjusting stations are arranged one behind the other.

19. The method according to claim 11, wherein each of the temperature-adjusting stations has at least one temperature-adjusting plate, and each of the temperature-adjusting stations is operated by the least one temperature-adjusting plate.

20. The method according to claim 11, further comprising transporting the steel blank between the plurality of temperature-adjusting stations using a manipulator, wherein the manipulator is between adjacent temperature-adjusting stations of the plurality of temperature-adjusting stations.

21. The method according to claim 11, wherein the heating of the steel blank is performed in a last temperature-adjusting station of the plurality of temperature-adjusting stations at a heating rate of 5 to 15 K/s before the hot-forming and the press-hardening.

22. A temperature-adjusting station, the temperature-adjusting station comprising:
at least one temperature-adjusting plate configured to adjust a temperature of a steel blank at least in certain portions of the steel blank; and
a heating conductor in the temperature-adjusting plate,
wherein the heating conductor is configured to heat the temperature-adjusting plate and to inductively heat the steel blank.

23. The temperature-adjusting station according to claim 22, further comprising a second temperature-adjusting plate, the second temperature-adjusting plate has an abutment on an opposite side of the steel blank, the second temperature-adjusting plate being partially actively heatable.

24. The temperature-adjusting station according to claim 22, wherein the temperature-adjusting plate comprises a non-magnetic material.
